(19) United States
(12) Patent Application Publication
(10) Pub. No.: US 2026/0365897 A1
(43) Pub. Date: Nov. 19, 2026

(54) Functional Element with Intumescent Material

(71) Applicant: Viega Technology GmbH & Co. KG, Attendorn (DE)

(72) Inventors: Nils Hoffmann, Attendorn (DE); Bastian Schauerte, Attendorn (DE); Mario Pace, Lennestadt (DE)

(21) Appl. No.: 19/674,249

(22) Filed: May 12, 2026

(30) Foreign Application Priority Data
May 13, 2025 (DE) 102025118413.5

(51) Int. Cl. C09K 3/10

(52) U.S. Cl. CPC C09K 3/1006; C09K 2003/1037

(57) ABSTRACT

The invention relates to a functional element for sealing a component in the event of a temperature increase, having a main body, wherein the main body includes or consists of a functional portion, wherein the functional portion includes a material, wherein the material includes an intumescent material and a thermoplastic polymer, wherein the thermoplastic polymer is cross-linked. The invention further relates to the use of a material including a cross-linked thermoplastic polymer and an intumescent material in a functional element for a component, for sealing the component in the event of fire.

### CROSS-REFERENCE TO RELATED APPLICATION

This application claims priority to German Patent Application No. 102025118413.5 filed May 13, 2025, the disclosure of which is hereby incorporated by reference in its entirety.

### BACKGROUND OF THE INVENTION

### Field of the Invention

The present invention relates to a functional element for sealing a component in the event of a temperature increase, comprising a main body made of a material, wherein the material comprises an intumescent material and a thermoplastic polymer.

### Description of Related Art

The relevant technical field for the present invention is the on-site installation of conduit systems, in which a conduit system consisting of pipe sections and fittings is generally installed for conducting and guiding a fluid, i.e., a liquid or a gas. A fitting is generally understood to be a connecting piece for a pipe, and a fitting is most often used to connect two or more pipe sections. The fitting therefore preferably has two or more compression sections - for example, in the form of compression sleeves. The most common fittings include straight connections, changes of direction in the form of pipe bends, reducers, branches such as tees or crossings. However, a fitting can also refer to a conduit connection of a valve or other component. For example, thermometers or pressure gauges, as fittings, only have one connection for a pipe section. As such, the fitting of a valve has only one compression section to connect a pipe section to the valve.

Compression connections are used to connect the pipe sections to the fittings and other components, in which connections a compression section of a fitting is radially deformed inwards by means of a crimping jaw when the pipe section is inserted, so that a permanent and tight, possibly even inseparable, connection is created. The fittings can be provided with a sealing agent, e.g., an O-ring, which ensures the tightness of the connection, or can be designed by means of direct contact between the materials of the pipe section and the fitting - for example, with metallic sealing.

Predominantly radially-acting crimp systems are used for radial deformation of the compression section, as are crimp systems that use radial/axial compression, wherein, during the compressing process, a part of the fitting is axially displaced in order to achieve radial deformation.

The previously generally described pipe systems serve in particular to transport drinking or heating water, gas for the operation of a heating system, or industrial gases. In principle, any fluid medium can be transported in the pipes.

Compression fittings are differentiated based on whether a pipe is sealed and fixed from the outside during compression, or whether at least part of the fitting, e.g., in the form of a support sleeve, stabilizes the pipe to be sealed from the inside. The present invention relates in particular to the type of fittings in which the pipe is sealed and fixed from the outside. This does not fundamentally preclude the possibility of a component of the fitting being located inside the pipe, but this is usually not the case. Furthermore, the present invention can also be used for pipes that are to be sealed from the inside.

Solid materials are preferably used as materials for pipes that need to be sealed from the outside - for example, rigid pipes. Suitable materials include, in particular, metallic materials, e.g., stainless steels such as ferritic steels like 1.4520, 1.4521, austenitic steels such as 1.4404, duplex steels such as 1.4462, copper-based alloys such as brass, red brass, silicon bronze and pure copper.

Non-metallic materials such as plastics can also be considered solid materials if the non-metallic material or plastic has sufficient properties for compression and permanently connecting to pipes. The following materials, for example, are suitable: polyethylene (PE), in particular cross-linked polyethylene (PE-X), peroxide-cross-linked polyethylene (PE-Xa), silane-cross-linked polyethylene (PE-Xb) or physically cross-linked polyethylene (PE-Xc), polyethylene with increased temperature resistance (PE-RT), polyvinyl chloride (PVC), polypropylene (PP) at appropriate wall thicknesses, polyphenyl sulfone (PPSU), polyaryl ether ketone (PAEK), in particular polyether ether ketone (PEEK), polyamide (PA), in particular aliphatic bio-based polyamide, e.g., PA410, PA12, PA12-GF30, PA11, PA610, PA66, PA6, PA1010, or polypropylene random copolymer with modified crystal structure and increased temperature resistance (PP-RCT). Furthermore, multilayer composite pipes can be sufficiently rigid for external sealing, e.g., via a thicker aluminum layer; fiber-reinforced pipes can also be used.

For the purposes of this application, a rigid pipe is understood to be a pipe that is connected to an externally sealing fitting. The strength of the pipe material is sufficient to ensure that the forces acting from the outside through the fitting provide a permanent seal, but do not deform the rigid pipe, or only deform it so little that the connection remains stable and tight.

Fittings for compression connection with a pipe, in particular a pipe to be sealed from the outside, e.g., a rigid pipe, can have various designs. A functional element can be provided inside the fitting; additional fixing elements can also be provided. Functional elements and optional fixing elements can fix the pipe in the required position relative to the fitting before and after compression and/or hold the pipe in the fitting against the pull-out direction. The functional element is therefore preferably used as a retaining element. Furthermore, the functional element can alternatively or additionally serve as a spacer between other elements provided inside the fitting. In addition, the functional element can alternatively or additionally fulfill the function of a sealing element and seal existing gaps between other elements of the fitting and/or the arrangement for compression connection. In addition to the functional element, a sealing element, usually a sealing ring, e.g., an O-ring, may be provided to seal the fitting against the outside of the pipe.

The optional sealing element lies flush against the compression sleeve and the inserted pipe when compressed, since it is located in the region of the stop element, i.e., where the inserted pipe rests and ends. Besides creating an improved seal of the connection, the absence of gaps also serves to improve hygiene, since dead spaces and regions prone to stagnation are avoided. Depending on the further design of the fitting, a reliable seal can also be achieved with a compression-fitted arrangement of pipe and fitting without a sealing element.

The securing of the pipe against pull-out and/or against excessive internal pressure is preferably achieved via a functional element serving as a retaining element, wherein the inner surface of the main body is designed accordingly to hold and/or fix the pipe. The main body of the functional element is preferably substantially hollow-cylindrical, and can therefore be designed, for example, as a ring whose outer contour is adapted to the inside of the main body of the fitting. It is also possible that the main body is made in one piece or composed of multiple elements.

After the fitting is compression-fitted to the pipe, a reliable seal can be achieved, allowing pressurized fluids to be passed through the compression-fitted arrangement of pipe and fitting without loss.

If the pressurized fluid is a gas, it is necessary for safety reasons to achieve a gas-resistant seal that allows for substantially loss-free passage of the gas through the compression-fitted arrangement of pipe and fitting, even at high temperatures. A gas installation is required to be HTL-resistant. The term high thermal load (HTL) resistance refers to the requirement that gas pipework, e.g., a gas-carrying pipe, be able to withstand a temperature exposure of, for example, 650 °C for a period of 30 minutes. The temperature requirement depends on the relevant guidelines (e.g., European standard EN 1775:2007 and German regulation DVGW G 5614) - for example, the EU directives in EU member states. This prevents the gas pipework from posing an explosion hazard in the event of a fire, unless the explosion hazard is prevented by alternative protective measures. As part of an HTL test of an arrangement consisting of a fitting compression-connected to a pipe, the arrangement is exposed, for example, to a temperature of 650 °C for 30 minutes and the leakage rate is measured under a certain internal pressure, which rate must not exceed a certain value. Furthermore, resistance to high temperatures is also necessary or at least advantageous for fluids other than gas, so that an HTL-resistant installation is generally preferable for fluid-carrying pipe systems.

HTL resistance is particularly problematic in combinations of fittings and pipes where material combinations with different coefficients of thermal expansion are used, e.g., a compression connection with a fitting made of a ferritic steel, e.g., 1.4521, and a pipe made of an austenitic steel - for example, 1.4404. This is because, when using material combinations with different coefficients of thermal expansion, an increase in temperature, e.g., through heating during the HTL test, results in enlarged gaps between pipe and fitting, which can lead to insufficient or borderline tightness of the compression connection. However, even with material-pure combinations of pipe and fitting, e.g., in a compression connection with a fitting and a pipe made of an austenitic steel, e.g., 1.4404, enlarged gaps and consequently a lack of tightness of the compression connection can occur when the compression connection is heated. A particular problem with temperature increases in a compression connection with a sealing element, which is often made of rubber, e.g., HNBR ("hydrogenated nitrile-butadiene rubber"), is that the sealing element can be completely destroyed and therefore can no longer provide a seal. This is particularly problematic at temperatures of up to 650 °C, such as those encountered during the HTL test.

In existing arrangements for compression connections consisting of fitting and pipe, an additional component is often used which, for example through expansion, is intended to fill and thus seal the gaps that arise during the HTL test. A disadvantage of this solution is that the additional component must be inserted as an additional component into an arrangement for compression connection consisting of fitting and pipe. On the one hand, this results in an increased space requirement within the fitting - for example, in the chamber of the fitting. On the other hand, providing an additional component increases the production effort.

Furthermore, intumescent materials are known from the prior art, e.g., intumescence-based additives which expand or foam up by many times their volume when the temperature increases, and can thus serve or contribute to sealing. Intumescence generally refers to the property of a substance of expanding or swelling when its temperature increases. Intumescence is therefore an increase in the volume of a solid body without chemical transformation when thermal energy is applied. Foamed intumescent-based additives are heat-resistant and slow down or prevent the passage of thermal energy through the material containing the intumescent-based additive.

Intumescent materials are characterized by the fact that they begin to expand at a certain temperature, which is usually between 200 and 350 °C. They are used as seals, e.g., as sealing strips in buildings, or in the form of a paste - for example, in the form of a flame-retardant layer. In the event of a fire, intumescent materials perform the important function of sealing cavities, gaps and joints that may result from the expansion of the different components of the building element or a building. Unlike flame-retardant plastic parts, such intumescent materials generally have no function outside of a fire involving a temperature increase of the component in which the material is used. In addition, the use of intumescent materials has so far been limited to a few areas.

Furthermore, the prior art includes the use of components comprising intumescent materials, which include thermoplastic polymers with a processing temperature below the trigger temperature of the intumescent components. Thermoplastic polymers are plastics that can be reversibly deformed within a specific temperature range. The intermolecular forces that connect the polymer chains weaken rapidly with increasing temperature, resulting in a viscous liquid. In such components, the melting temperature of the thermoplastic polymers is reached before the intumescent component begins to expand. In a pipe system, in the event of a temperature increase, e.g., due to a fire, the internal pressure of the pipe system consequently causes the thermoplastic polymer to form a thermoplastic melt, which, due to the acting shear forces, is carried out of the connecting piece together with the intumescent material before the intumescent material can trigger. This reduces the intended sealing effect in the event of fire.

Furthermore, pyrolytic decomposition of thermoplastic polymers at temperatures reached during fire results in material loss as well as a reduction in the viscosity of the thermoplastic melt, which further intensifies the aforementioned effect of reduced sealing performance. Such pipe systems therefore demonstrate a lack of tightness in the HTL test.

The use of elastomers in intumescent components is also known. In the event of a fire, however, elastomers are even less suitable than thermoplastic polymers at withstanding the increased internal pressure of the pipe system until the intumescent material triggers.

Against the background of the disadvantages of the prior art described above, the present invention is based on the technical problem of developing a functional element that achieves a largely complete seal of a component even at high temperatures.

### SUMMARY OF THE INVENTION

This technical problem is solved according to the invention, for a functional element for sealing a component in the event of a temperature increase, comprising a main body, wherein the main body comprises or consists of a functional portion, wherein the functional portion comprises a material, wherein the material comprises an intumescent material and a thermoplastic polymer, by the thermoplastic polymer being cross-linked. The intumescent material can be distributed within the cross-linked thermoplastic polymer serving as the matrix material. Preferably, the functional portion consists of the material. The functional portion could, for example, be a collar or a coating. The main body can comprise more than one functional portion - for example, two or three functional portions. For example, an annular main body can comprise two narrow collars at its ends.

Furthermore, the technical problem is solved by using a material comprising a cross-linked thermoplastic polymer and an intumescent material in a functional element for a component, to seal the component in the event of fire. The functional element can consist partially or completely of the material. The functional element may have a functional portion that comprises or consists of the material.

The functional element according to the invention eliminates the need for an additional sealing element in the event of fire, and simultaneously prevents the escape of gases or other media. This is particularly effective in achieving HTL resistance in components where materials with different coefficients of thermal expansion are present.

The functional element according to the invention has a main body comprising a functional portion on which further elements can optionally be arranged in order to fulfill the required function of the functional element. For example, elements may be present that serve a function of the functional element as a retaining element, such as fixing elements for fixing the pipe, which guide and hold the pipe to be inserted. Furthermore, elements may be provided that support a function of the functional element as a spacer element or sealing element, e.g., elements made of a material that is softer than the rest of the main body, which serve as a seal.

By means of the design according to the invention of the main body comprising a functional portion, wherein the functional portion comprises a material, wherein the material comprises an intumescent material, an expansion of the functional element in parts or as a whole by multiple times its volume can be achieved in the event of fire as a reaction to heat. In this way, the functional element or portion thereof can reliably close gaps that arise in a component due to heat exposure, and ensure a seal even in the event of a fire. The functional element can therefore be advantageously used in conjunction with materials that have different coefficients of thermal expansion.

As mentioned above, a particular disadvantage of using thermoplastic polymers in a functional element is that the melting temperature of the thermoplastic polymers is reached before the intumescent component begins to expand, and thus the resulting thermoplastic melt is carried out of the connecting piece along with the intumescent material before the intumescent material can trigger. Without wishing to be bound to a scientific theory, cross-linked thermoplastic polymers, in contrast, appear to form a gel above their melting temperature. In the event of a fire, instead of a thermoplastic melt, a stationary gel appears to form due to the cross-linking of the thermoplastic polymer, which gel withstands the internal media pressure long enough that the intumescent component can be triggered in a targeted and complete manner at the point of need, and expand in volume to seal the area. Furthermore, due to this gel structure, the aforementioned reduction in viscosity through pyrolytic decomposition of the thermoplastic polymer appears to be delayed, thus further extending the sealing time during the fire.

Furthermore, functional elements comprising cross-linked thermoplastic polymers have the advantage, especially compared to functional elements comprising elastomers, that elastomer parts cross-link over a long time period after they have been shaped by injection molding or pressing. This is usually followed by tempering over several hours at high temperatures to achieve the desired quality for seals designed for a 50-year lifespan. The functional elements according to the invention are subject to lower thermal stress, are faster (and cheaper) to manufacture, and easier to assemble.

In the following, various embodiments of the functional element are described, wherein the individual embodiments can also be combined with one another.

According to a preferred embodiment, the functional element is designed such that, through the component, anisotropic forces act on the functional element in the installed and/or operating state. The anisotropic forces can, for example, be shear and/or frictional forces acting on the functional element in the installed and/or operating state. In particular, the frictional forces can be present between the functional element and the component. In particular, the anisotropic forces can exert a shear force on the functional element. The shear force is primarily a consequence of the installation situation of the functional element in a pipe system and the internal pressure in a pipe system caused by a medium carried therein. In the cold (solid) state, the shear force is not critical. In the event of a fire, the shear force causes a non-cross-linked thermoplastic melt to flow, particularly due to dynamic viscosity and viscosity reduction through shear.

Preferably, the component is designed to conduct a fluid, in particular a gas, which preferably exerts a force on a side of the component that is in contact with the fluid. For example, the fluid can exert a force on an inner surface of the component. The fluid can also exert anisotropic forces on the component and on the functional element, especially on the functional portion. In particular, the component is designed for pipes for the transport of gas for the operation of a heating system or for industrial gases. In principle, however, any fluid medium can be transported into the component comprising pipes according to the invention.

Furthermore, according to a preferred embodiment, due to the component, the magnitude of the anisotropic forces acting on the functional element in the installed and/or operating state can be greater than the magnitude of the gravitational force acting on the component. In particular, when installed and/or in operation, the anisotropic forces act on the functional element through the component in addition to the gravitational force of the component. Preferably, the gravitational force is not taken into account in the anisotropic forces acting through the component on the functional element in the installed and/or operating state. As already mentioned, the anisotropic forces can, for example, be shear and/or frictional forces acting on the functional element in the installed and/or operating state.

According to a preferred embodiment, the anisotropic forces acting through the component on the functional element in the installed and/or operating state result in a resulting force vector that is not equal to zero. Part of the anisotropic forces that form the resultant force vector can also be a fluid that is guided through the component.

Furthermore, it is preferred that at least one shear force act on the functional element, in particular the functional portion, due to the anisotropic forces in the installed and/or operating state.

According to a preferred embodiment, the thermoplastic polymer is polyethylene and/or the material comprises cross-linked polyethylene. The cross-linked thermoplastic polymer included in the material is therefore cross-linked polyethylene. In other words, the functional portion of the main body, or the main body as a whole, is therefore preferably made of a material comprising an intumescent material and cross-linked polyethylene. During the production of cross-linked polyethylene, strong bonds are irreversibly formed between the macromolecules of polyethylene through a three-dimensional cross-linking process. The three most common methods for crosslinking are peroxide crosslinking according to the Engel process (PE-Xa, chemical crosslinking), silane crosslinking (PE-Xb, chemical crosslinking) and electron beam crosslinking (PE-Xc, physical crosslinking). In addition, azo crosslinking is known as another chemical crosslinking technique (PE-Xd). The cross-linked thermoplastic polymer PE-Xb comprised in the material is particularly preferred. The polyethylene (PE) used to produce cross-linked polyethylene can be LLDPE, MDPE, HDPE or blends thereof.

Without wishing to be bound to a scientific theory, it seems that the crosslinking structure of the polymer, especially of cross-linked polyethylene, can counteract the shear forces caused by the internal pressure of the medium within the pipe system which act on the resulting thermoplastic melt in the event of a fire. These forces can prevent further flow of the thermoplastic melt, so that both the thermoplastic melt and the intumescent material remain in place and the intumescent material is triggered at the desired location. This prevents the thermoplastic polymer and the intumescent material from being carried out by the internal pressure of the medium in the event of a fire. Polyethylene also has the advantage of exhibiting high resistance to a wide variety of fluids and other agents. Furthermore, the processing of polyethylene is established in practice.

According to an embodiment, the cross-linked thermoplastic polymer, comprised in the material, exhibits a shape-memory effect. Preferably such a cross-linked thermoplastic polymer with shape-memory effect is mounted in a stretched state.

Without wishing to be bound to a scientific theory, it seems that by mounting a cross-linked thermoplastic polymer with shape-memory effect in a stretched state, an improved sealing of the component can be achieved in the event of a temperature increase. When mounting the stretched cross-linked thermoplastic polymer it is deformed from its original stretched shape. Due to the shape-memory effect, the mounted cross-linked thermoplastic polymer is subject to a force that drives it to expand in order to return to its original stretched shape. In the event of a temperature increase, this can result in an additional sealing effect in a component comprising the functional element according to the invention, as the cross-linked thermoplastic polymer mobilized by the initial heating presses against the walls of the component.

Various materials are suitable as the intumescent material. The intumescent material is expediently selected from the group consisting of expandable graphite, activated melamine pyrophosphates, activated melamine polyphosphates, activated ethylene diamine phosphates, activated ammonium polyphosphates, melamine, melamine phosphate, non-activated melamine pyrophosphates, non-activated melamine polyphosphates, melamine cyanurates, alkali silicates, alkali aluminosilicates, alkali magnesium silicates, phosphates, phosphate-containing silicates or aluminates, inorganic boron compounds, carbohydrates such as mono-, di- or polysaccharides like sugars, starch, cellulose, materials with bound water of crystallization, such as vermiculite and mixtures thereof. Carbohydrates may interact with salts of strong inorganic acids, such as phosphoric acid or sulfuric acid. According to another preferred embodiment, the intumescent material is expandable graphite. Expandable graphite is preferably produced by chemical treatment of graphite, wherein graphite is treated with substances and these are incorporated into the lattice structure of the graphite, thereby widening the layer spacing of the graphite layers. Graphite treated in this way expands when exposed to heat, multiplying its volume. Preferred substances include, for example, strong acids, especially mineral acids such as sulfuric acid or nitric acid, and/or oxidizing agents such as hydrogen peroxide or potassium permanganate.

Advantageously, the material contains the intumescent material in an amount of 10 to 45 wt.%, preferably 15 to 40 wt.%, particularly preferably 20 to 35 wt.%, particularly preferably 25 to 30 wt.%, based on the total weight of the material. Such a proportion is particularly effective for sealing in the event of fire. It has been found that with such a proportion of intumescent material of 10 to 35 wt.%, preferably 15 to 30 wt.%, the functional element can effectively reduce the risk of explosion of gas-carrying pipes by sealing the gas-carrying pipes, especially with satisfactory holding/fixing behavior.

According to a preferred embodiment, the component is a compression connection, in particular a press fitting. Compression connections ensure a reliable seal, allowing pressurized fluids to be conveyed without loss through the compression-fitted arrangement of pipe and fitting.

Preferably, the functional element is a clamping element, a sealing element or a retaining element. A clamping element serves to secure the pipe against pull-out and/or excessive internal pressure by absorbing the pull-out force through point deformation of the pipe. A sealing element seals gaps between other elements of the fitting and/or the arrangement for compression connection. A retaining element fixes the pipe in the required position relative to the fitting before and after compression and/or holds the pipe in the fitting against the pull-out direction.

If the functional element is used in conjunction with a pipe, various materials are suitable for the pipe, especially metallic and non-metallic materials. Examples of metallic materials include stainless steels such as ferritic steels like 1.4520, 1.4521, austenitic steels like 1.4404, duplex steels like 1.4462, copper-based alloys such as brasses, red brass, silicon bronze and pure copper. Examples of non-metallic materials include polyethylene (PE), in particular cross-linked polyethylene (PE-X), peroxide-cross-linked polyethylene (PE-Xa), silane-cross-linked polyethylene (PE-Xb) or physically cross-linked polyethylene (PE-Xc), polyethylene with increased temperature resistance (PE-RT), polyvinyl chloride (PVC), polypropylene (PP) at appropriate wall thicknesses, polyphenyl sulfone (PPSU), polyaryl ether ketone (PAEK), in particular polyether ether ketone (PEEK), polyamide (PA), in particular aliphatic bio-based polyamide, e.g., PA410, PA12, PA12-GF30, PA11, PA610, PA66, PA6, PA1010, or polypropylene random copolymer with modified crystallinity and increased temperature resistance (PP-RCT).

The invention further relates to a fitting comprising a functional element described herein. A fitting can be used in particular to connect pipes.

The invention further relates to a system for creating a conduit connection to a pipe, in particular a composite pipe, and with a functional element described herein. Preferably, the system according to the invention has a fitting as described herein.

Finally, the invention relates to the use of a functional element or a fitting or a system described herein in a conduit arrangement carrying a fluid, in particular a gas.

### BRIEF DESCRIPTION OF THE DRAWINGS

The invention will now be explained using exemplary embodiments with reference to the drawings. In the drawings:

FIG. 1 is an exemplary embodiment of a functional element according to the invention,

FIGS. 2a-e show an exemplary embodiment of a fitting for connecting to a pipe, to be sealed from the outside, with a functional element according to the invention as shown in FIG. 1,

FIGS. 3a-b show a comparative example of a fitting without a functional element.

### DESCRIPTION OF THE INVENTION

In the following description of the various exemplary embodiments according to the invention, components and elements with the same function and mode of operation are provided with the same reference signs, even if the components and elements may differ in their dimensions or shape in the various exemplary embodiments.

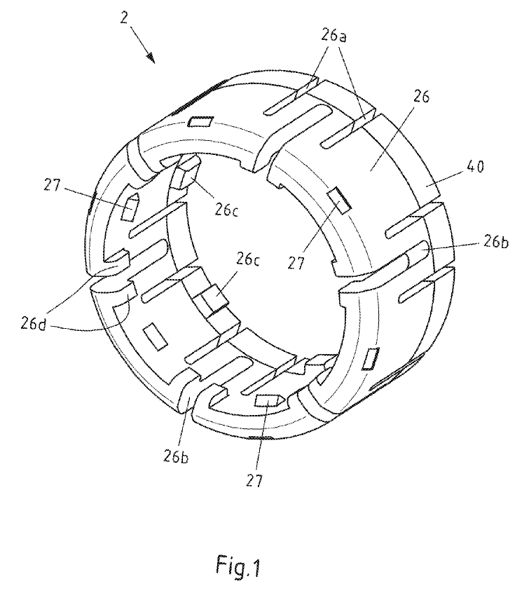

FIG. 1 shows an exemplary embodiment of a functional element 2 according to the invention, in which the main body 26 has, as a functional portion 40, a collar which consists of cross-linked polyethylene mixed with expandable graphite. In this exemplary embodiment, the proportion of expandable graphite in the material of the functional portion 40 is 25 wt.%. The rest of the main body 26 can consist of the same cross-linked polyethylene (without expandable graphite) or of another material. As described above, the entire main body 26 can also consist of cross-linked polyethylene mixed with expandable graphite.

Metallic cutting elements are arranged as clamping elements 27 in the main body. The main body also has circumferential slots 26a and 26b, which make the main body 26 and thus the functional element 2 as a whole flexible and facilitate installation in a fitting. In addition, this means the main body 26 can be designed as a completely closed ring, and its radius can be more easily reduced during compression.

The clamping elements 27 are designed as cutting elements in the form of wire elements which are inserted into recesses provided for this purpose. The clamping elements 27 are thus fixed in the main body 26 in a form-fitting manner. The clamping elements 27 can be produced in various ways - for example, as castings or as stamped parts. The number of clamping elements 27 is six in the present case, but can be determined according to the requirements or dimensions of the main body 26.

Furthermore, the main body 26 has inwardly directed webs 26c spaced apart from the clamping elements 27, wherein the webs 26c define an inner cross-section that is equal to or slightly smaller than the outer diameter of a pipe 4 to be inserted. In addition, inwardly directed webs 26d are also formed, which guide a pipe 4 to be inserted during its insertion.

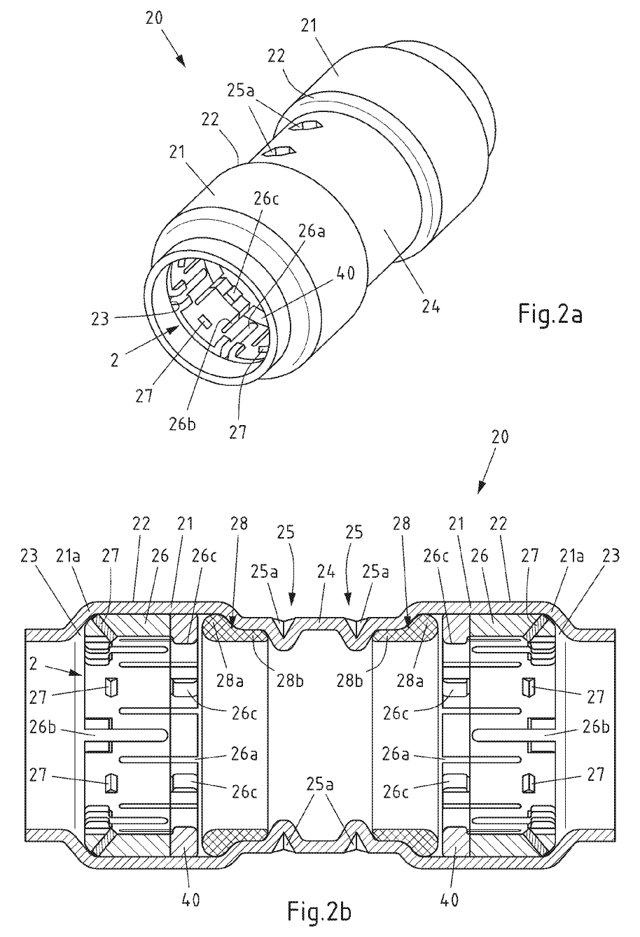

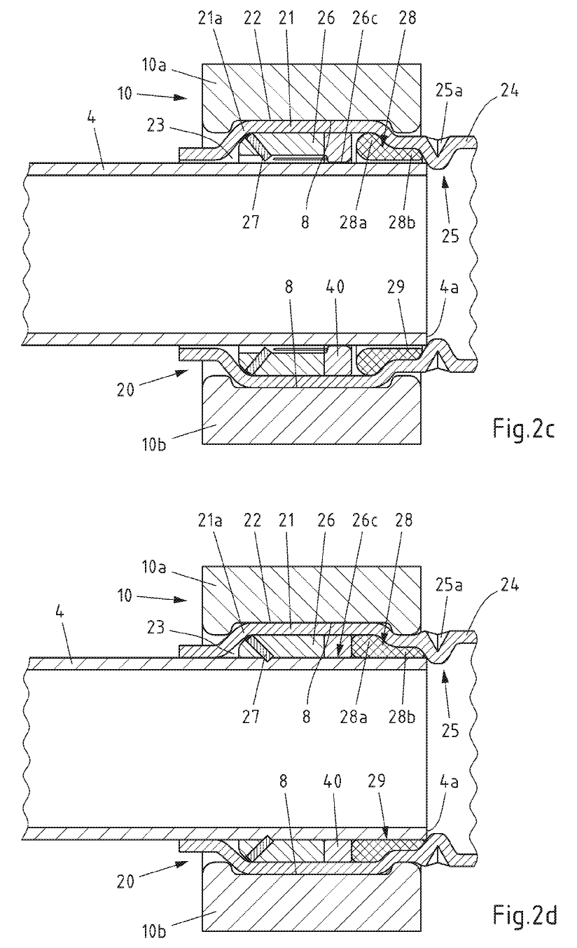

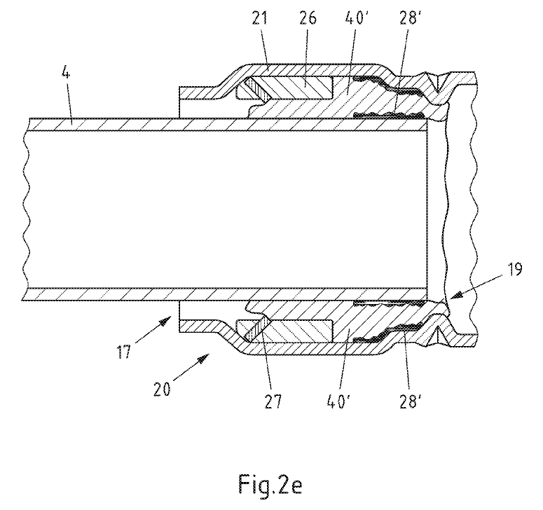

FIGS. 2a - 2e show an exemplary embodiment of a fitting 20 for connecting to a pipe 4, to be sealed from the outside, with a functional element 2 previously explained with reference to FIG. 1. FIGS. 2a - 2c show the fitting 20 in the non-compressed state, whereas FIG. 2d shows the fitting 20 in the compressed state. In FIG. 2e, the fitting 20 is shown in the compressed state after exposure to heat.

The fitting 20 has a main body 24 and a stop element 25 formed in the main body 24 on the circumference thereof and projecting inwards. Furthermore, a compression sleeve 21 is provided, which is connected to the main body 24 and forms an outer contour 22, and which has a chamber 23 directed inwards towards the pipe 4 being received. A functional element 2 according to FIG. 1 is arranged in the chamber 23. In addition, a sealing element 28 is arranged in the chamber 23 adjacent to the stop element 25, and has a round portion 28a and a flat portion 28b forming a lip seal.

The compression sleeve 21 is integrally connected to the main body 24, so that the compression portion in the form of the compression sleeve 21 and the main body 24 can advantageously be manufactured as a single piece. The stop element 25 is made in this case of two inwardly directed and radially opposite depressions 25a, which are designed, for example, as center punch points. The pipe stop is therefore made at a single point and not around the circumference, thus avoiding dead spaces, even when a pipe 4 is inserted and the seal 28 seals in the region of the stop element 25. In FIG. 2b, a pair of radially opposite center punch points is shown for each side of the fitting 20 - one pair for each side of the fitting.

The securing of the pipe 4 against pull-out and/or against excessive internal pressure is achieved via the functional element 2, which serves here as a retaining element. The circumferential slots 26a and 26b, which are provided on the main body 26, facilitate installation in the fitting 20 inside the compression sleeve 21.

The clamping elements 27 of the main body 26 are arranged in the distal region, opposite the stop elements 25, of the chamber 23 and absorb the pull-out force by virtue of the fact that the clamping elements 27 deform the pipe 4 at specific points (see FIG. 2d), bearing against the wall in a distal, outer corner region 21a of the compression sleeve 21. A direct force flow from the pipe 4 via the compression sleeve 21 into the fitting 20 is thus ensured. The functional element 2 has only a supporting function after compression, and contributes only slightly or not at all to the pull-out protection.

The webs 26c hold the pipe 4 in the non-compressed state of the fitting 20 according to FIG. 2c, so that the pipe 4 cannot slip out of the fitting 20. In addition, the webs 26c form a guide for the pipe 4 when it is pushed into the fitting 20. If the inner cross-section of the inner surfaces of the webs 26c is slightly smaller than the outer diameter of the pipe 4, the pipe 4 will encounter a slight resistance when being inserted. As such, when the pipe 4 is inserted, the user receives haptic feedback that the pipe 4 is inserted into the fitting.

The seal 28 is in contact with the functional portion 40 and is designed as a lip seal with portions 28a and 28b, and, after crimping, seals the gap 29 between the pipe 4 and the compression sleeve 21 up to the end 4a of the inserted pipe 4. The seal 28 rests on one side with the round portion 28a inside the chamber 23 against an inclined portion, and is accordingly positioned. The flat portion 28b is arranged between the compression sleeve 21 and the pipe 4 to be inserted, which is particularly evident in the compressed state in FIG. 2d. After compression, the gap 29 is thus filled in.

The compression process can be seen clearly by comparing FIGS. 2c and 2d. The two press jaws 10a and 10b are moved radially inwards and the compression sleeve 21 is deformed radially inwards by the contact of the press contour 8 of the two press jaws 10a and 10b. This causes the functional element with the main body 26 to be deformed in such a way that the clamping elements 27 press inwards into the material of the pipe 4, thus achieving the fixation of the pipe 4 and the fitting 20. On the other hand, when the compression sleeve 21 is deformed, the seal 28 and in particular the portion 28b as a lip seal are also deformed radially inwards, and the seal 28 seals the gap 29.

The sealing element 28 thus ensures a high level of hygiene and prevents crevice corrosion. Furthermore, a particularly tight connection is achieved. As such, in conjunction with the point-contact pipe stop, 25 dead spaces are avoided in which media can collect. The lip seal continues to ensure system tightness.

This high level of tightness can be ensured particularly in the event of a fire, when the fitting is exposed to heat for a longer period of time - for example, at a temperature of 650 °C for a period of 30 minutes according to an HTL test. This is shown in FIG. 2e. Due to the heat exposure, gaps 17 and 19 have formed between the compression sleeve 21 and the pipe 4. However, the gap 19 is closed off by the material, enlarged many times in volume, of the expanded or foamed functional portion 40' of the main body 26', so that the medium carried in the pipe 4 cannot escape from the compression connection made of the pipe 4 and fitting 20. As such, if a gas is carried in the pipe 4, for example, the risk of explosion in the event of a fire can be reduced or even avoided. In contrast to the functional element 2 with intumescent material, the sealing element 28 cannot withstand the heat and is almost completely destroyed. Only remnants 28' of the sealing element remain in the gap 19 between the pipe 4 and compression sleeve, but cannot close it.

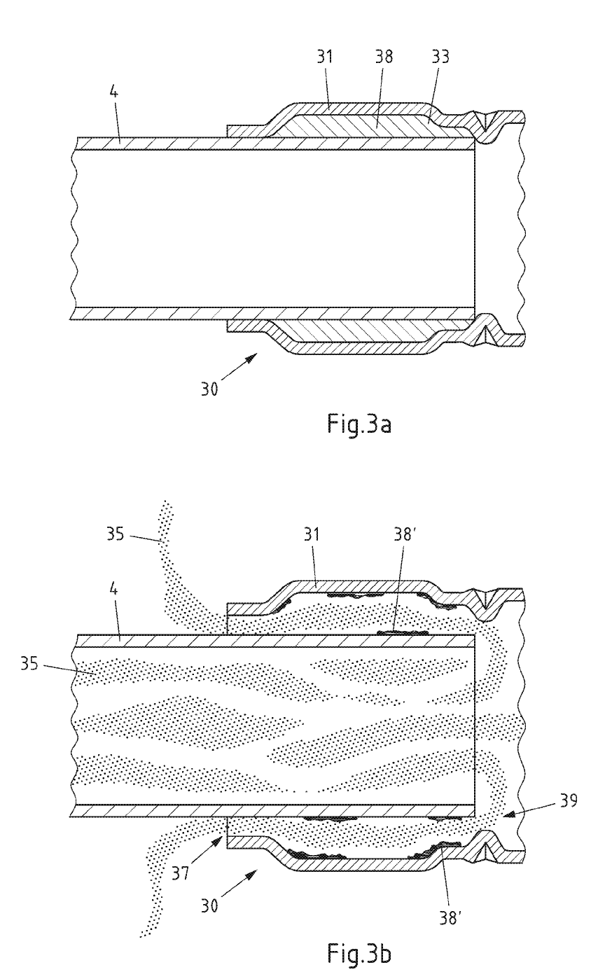

FIGS. 3a and 3b show, to illustrate the effect of the functional element 2 according to FIGS. 1 and 2, a fitting 30 without a functional element, in which only a sealing element 38 is arranged in the chamber 33 between the pipe 4 and compression sleeve 31. FIG. 3a shows the compressed state of the fitting 30 at room temperature, whereas FIG. 3b shows the compressed state of the fitting when subjected to heat - for example, during an HTL test. In the compressed state at room temperature according to FIG. 3a, the sealing element 38 closes off the gap between the compression sleeve 31 and the pipe 4, so that a fluid-tight compression connection between the pipe 4 and the fitting 30 is achieved.

FIG. 3b shows that the heat causes gaps to form between the compression sleeve 31 of the fitting 30 and the pipe. It is evident that, under the influence of heat, the sealing element 38 is almost completely destroyed as compared to FIG. 3a, so that only remnants 38' of the sealing element remain in the gaps 37, 39. These remnants 38' are no longer able to seal the gaps 37, 39, so that the medium 35 carried in the pipe 4 can escape from the compression connection made of the pipe 4 and fitting 30, as shown in FIG. 3b. In contrast to the exemplary embodiment of the fitting 20 according to the invention having the functional element 2 as shown in FIGS. 1 and 2, the fitting 30 thus causes an acute safety risk in the event of a fire, especially if the medium 35 carried in the pipe 4 is an explosive gas.

1. A functional element for sealing a component in the event of a temperature increase, comprising a main body, wherein the main body comprises or consists of a functional portion, wherein the functional portion comprises a material, wherein the material comprises an intumescent material and a thermoplastic polymer, wherein the thermoplastic polymer is cross-linked.

2. The functional element according to claim 1, wherein the functional element is designed such that, through the component, anisotropic forces act on the functional element in the installed and/or operating state.

3. The functional element according to claim 1, wherein the component is designed to conduct a fluid, in particular a gas, which preferably exerts a force on a side of the component that is in contact with the fluid.

4. The functional element according to claim 2, wherein the magnitude of the anisotropic forces acting, through the component, on the functional element in the installed and/or operating state is greater than the magnitude of the gravitational force of the component.

5. The functional element according to claim 2, wherein the anisotropic forces acting, through the component, on the functional element in the installed and/or operating state produce a resulting force vector that is not equal to zero.

6. The functional element according to claim 2, wherein at least a shear force acts on the functional element in the installed and/or operating state due to the anisotropic forces.

7. The functional element according to claim 1, wherein the thermoplastic polymer exhibits a shape-memory effect and is preferably mounted in a stretched state.

8. The functional element according to claim 1, wherein the thermoplastic polymer is polyethylene and/or the material comprises cross-linked polyethylene.

9. The functional element according to claim 1, wherein the intumescent material is expandable graphite.

10. The functional element according to claim 1, wherein the material contains the intumescent material in an amount of 10 to 45 wt.%, preferably 15 to 40 wt.%, more preferably 20 to 35 wt.%, based on the total weight of the material.

11. The functional element according to claim 1, wherein the component is a compression connection, in particular a compression fitting and/or in that the functional element is a clamping element, a sealing element or a retaining element.

12. A fitting comprising a functional element according to claim 1.

13. A system for creating a conduit connection with a pipe, comprising a functional element according to claim 1.

14. The system of claim 13, further including a fitting.
